(19) United States
(12) Patent Application Publication
(10) Pub. No.: US 2025/0123681 A1
(43) Pub. Date: Apr. 17, 2025

(54) APPLICATION SERVER NODE, NETWORK NODE, CORE NETWORK NODE, AND METHODS IN A WIRELESS COMMUNICATIONS NETWORK

(71) Applicant: Telefonaktiebolaget LM Ericsson (publ), Stockholm (SE)

(72) Inventors: Hans Hannu, Lulea (SE); Peter Okvist, Lulea (SE)

(21) Appl. No.: 18/728,727

(22) PCT Filed: Jan. 12, 2022
(86) PCT No.: PCT/SE2022/050015

§ 371 Date: Jul. 12, 2024

(51) Int. Cl. G06F 3/01; H04L 65/1063; H04L 65/612; H04L 65/75; H04L 65/80; H04W 28/02

(52) U.S. Cl. CPC G06F 3/012; H04L 65/1063; H04L 65/612; H04L 65/765; H04L 65/80; H04W 28/0252

(57) ABSTRACT

A method performed by an application server node for handling a set of data packets comprising pictures in an extended Reality (XR) data transmission to be rendered for a user in a head mounted device associated to a communication device in a wireless communications network is provided. 5The application server node receives (401) movement data from the communication device. The movement data relates to a direction and a speed of a movement of any one or more out of: a head, body and an eye, of the user. The application server node identifies (402), in pictures to be displayed on the head mounted device according to the movement data, any one or more out of: a leading-edge part and/or a trailing-edge part, 10and their respective corresponding data packets comprised in the set of data packets. The application server node assigns (403) an importance value to each applicable respective data packet in the set of data packets depending on whether the data packet comprises a leading-edge part or a trailing-edge part of the pictures. The application server node sends (404) the set of data packets in the XR data transmission towards the 15communications device via a core network node and a network node. Each applicable data packet in the set of data packets indicates its assigned importance value. The data packets in the set of data packets are to be decided to be rendered for the user in the head mounted device based on the respective importance value.

### TECHNICAL FIELD

Embodiments herein generally relate to an application server node. a network node, a core network node and methods therein. More specifically, they relate for handling a set of data packets comprising pictures in an extended Reality (XR) data transmission to be rendered for a user in a head mounted device associated to a communication device in a wireless communications network. With the term XR, Augmented-, Virtual Reality, and mixes of these are included.

### BACKGROUND

Virtual Reality (VR) video and cloud gaming using HMDs are becoming increasingly popular. With the introduction of faster wireless networks such as 5G it is reasonably to believe that we will see a huge uptake also in the mobile networks.

Humans have 180 degrees Field of View (FOV) when looking directly in front and 270 degrees with eye rotation. The higher a Head Mounted Device's (HMD) FOV is, the further the virtual world will extend to an edge of a user's vision. Display FOV (dFOV) is the FOV of a user's HMD. While a wide dFOV may increase immersion and induce presence, it may cause simulator sickness in certain individuals, i.e. users. Humans are sensible to the flickers and movements of images in the peripheries of their visual systems. Hence, it is important that the image, e.g. video quality is high and stable in the dFOV of a user in order not to cause user discomfort.

Augmented reality where overlay of virtual objects onto a physical object is especially sensitive to slow rendering and “lag” that cause gaps between e.g., virtual contours immersed onto a physical object since a viewing user has an absolute reference in that how the physical objects is perceived to move. As a human's vision is interlinked with a mental expectation, such as understanding of the scene, the viewing user often puts more attention “into the expected future” of the scene, and less focus to parts of screen/scenery that already had happened. For example, in a tennis or soccer match, a viewing user have more attention to the approaching side of the ball or in the ongoing forward movement of the game since whatever that may happen in that region of the court/field is more relevant for next evolvement of the match than details of the racket or foot that just hit the ball is rendered.

### MOTION PREDICTION

For the sake of estimating “next” object, or typically next pixels to consider for image and/or video encoding, motion prediction is a well-known subject, i.e. to determine the block-wise or pixel-wise motion vectors between two frames.

There are basically two approaches, direct methods as well as so-called indirect methods.

Direct methods include lock-matching algorithms, phase correlations, frequency domain methods, pixel recursive algorithms, and optical flow assessment.

The so-called indirect methods use features, such as corner detection, and match corresponding features between frames, usually with a statistical function applied over a local or global area. Statistical functions are typically considered to remove matches that do not correspond to the actual motion.

The XR rendering uses motion prediction associated to the actual, for a user in FOV block-wise or pixel-wise motion vectors between two frames. Which two frames are describing an actual scenery in gaze of peripherical directions. This may be equally or more important for smooth and lag-free rendering. Apart from that in the XR rendering systems estimation of a user's physical head movements and/or in combination with rapid changes in the user's eyes' gazing direction is used to and is very important to distinguish what parts of the XR screen to consider for high quality=gaze, lower quality=peripheral rendering or not.

Examples of state-of-the-art solution related to XR HMD motion prediction and associated pre-rendering methods are described e.g., in:
“Head and Body Motion Prediction to Enable Mobile VR Experiences with Low Latency” [see https://ieeexplore.ieee.org/document/9014097].
“Motion Prediction and Pre-Rendering at the Edge to Enable Ultra-Low Latency Mobile 6 DoF Experiences” [see https://ieeexplore.ieee. org/document/9234536].

In the latter, a system layout suggested as illustrated by FIG. 1. The system layout includes VR glasses 10, also referred to as a VR headset tracking and legacy motion-based pixel rendering but also a technical component including VR glasses motion-prediction based rendering. The rendering and encoding are managed in an Edge Device 20 which in turn is communicating with a served VR device 30 over a network 40. The network 40 in the prototype is exemplified with an WiGig solution known as 60 GHz Wi-Fi.

### SUMMARY

As a part of developing embodiments herein the inventors identified a problem which first will be discussed.

Although 5G offers low round trip times and high bit rate, the capacity is limited, and users or services will need to be prioritized. Hence, it is reasonable to believe that some Quality of services (QOS) will be offered to cloud gaming and/or augmented application users that will give them priority over other services.

However, prioritizing e.g., only the cloud gaming users over other users may not be enough, especially in gaming hot spot areas. This may then cause discomfort to the user and prevent cloud gaming with HMD to become a success over a wireless access network.

Human vision of a user is rather sensitive to visual misalignment between “observed and expected” representation of objects presented at the user's screen. If contours of a soccer ball to follow the ball throughout a certain scene is expected, and some areas of the contour lags the edges of the ball, that will immediately be noticed and perceived as application or rendering lag.

Current state of the art solutions prioritize rendering of screen and/or pixels that belongs to a user's gazing direction and/or area, and such rendering is typically associated with higher resolution and higher refresh frequency frame rate. That motion prediction is used to predict what data to render next given e.g. motion of a ball, i.e. the updated position of a ball shown at the screen at from a point in time t to a future instance t+1 is predicted, and ball texture predicted to be used at t+1 is rendered in advance.

However, it is not known to consider respective leading and/or trailing bits relation to transmission layer packet importance values, and further traffic prioritizations thereof.

A leading part may mean a part of picture that is leading in a motion direction of the picture and a trailing part may mean a part of picture that is trailing in a motion direction of the picture.

An object of embodiments herein is to provide an improved way of handling data packets comprising pictures in an XR data transmission in a wireless communications network, to be rendered for a user in a head mounted device.

According to an aspect of embodiments herein, the object is achieved by method performed by an application server node for handling a set of data packets comprising pictures in an XR data transmission to be rendered for a user in a head mounted device, associated with a communication device in a wireless communications network. The application server node receives movement data from the communication device. The movement data relates to a direction and a speed of a movement of any one or more out of: a head, body and an eye, of the user. The application server node identifies, in the pictures to be displayed on the head mounted device according to the movement data, any one or more out of: a leading-edge part and/or a trailing-edge part, and their respective corresponding data packets comprised in the set of data packets. The application server node assigns an importance value to each applicable respective data packet in the set of data packets depending on whether the data packet comprises a leading-edge part or a trailing-edge part of the pictures. The application server node sends the set of data packets in the XR data transmission towards the communications device via a core network node and a network node. Each applicable data packet in the set of data packets indicates its assigned importance value. The data packets in the set of data packets are to be decided to be rendered for the user in the head mounted device based on the respective importance value.

According to another aspect of embodiments herein, the object is achieved by a method performed by a network node for handling a set of data packets comprising pictures in an XR data transmission to be rendered for a user in a head mounted device associated with a communication device in a wireless communications network. The network node receives from an application server node, a set of data packets in the XR data transmission towards the communications device. Each applicable data packet in the set of data packets indicates its assigned importance value. The importance value indicates whether the data packet comprises a leading-edge part of the pictures or a trailing-edge part of the pictures. The network node obtains a decision of whether the data packets in the set of data packets are to be rendered for the user in the head mounted device, based on the respective importance value. Based on the decision, the network node schedules the data packets in the set of data packets in the XR data transmission to be sent to the communications device and to be rendered for the user.

According to another aspect of embodiments herein, the object is achieved by a method performed by a core network node for handling a set of data packets comprising pictures in an XR data transmission to be rendered for a user in a head mounted device associated with a communication device in a wireless communications network. he core network node receives from an application server node, a set of data packets in the XR data transmission towards the communications device. At least one or more of the data packets indicate a respective assigned importance value. The respective importance value indicates whether its respective data packet comprises a leading-edge part or a trailing-edge part of the pictures. Based on the indicated importance value, the core network node decides a relevant QoS flow for at least each data packet in the set of data packets that comprises the importance value and maps the QoS flow to a corresponding Data Radio Bearer (DRB) setup to handle that QoS flow. The core network node sends towards the communications device, via a network node, the data packets in the set of data packets, in its respective mapped DRB. The data packets indicate its respective assigned importance value, and further indicate its respective decided relevant QoS flow. The data packets in the set of data packets are to be decided to be rendered for the user in the head mounted device based on the respective importance value and decided relevant QoS flow.

According to an aspect of embodiments herein, the object is achieved by an application server node configured to handle a set of data packets comprising pictures in an XR data transmission to be rendered for a user in a head mounted device associated with a communication device in a wireless communications network. The application server node is further configured to:

Receive movement data from the communication device, which movement data is adapted to relate to a direction and a speed of a movement of any one or more out of: a head, body and an eye, of the user,
identify, in the pictures to be displayed on the head mounted device according to the movement data, any one or more out of: a leading-edge part and/or a trailing-edge part, and their respective corresponding data packets comprised in the set of data packets,
assign an importance value to each applicable respective data packet in the set of data packets depending on whether the data packet comprises a leading-edge part or a trailing-edge part of the pictures,
send the set of data packets in the XR data transmission towards the communications device via a core network node and a network node, wherein each applicable data packet in the set of data packets is adapted to indicate its assigned importance value, and wherein the data packets in the set of data packets are adapted to be decided to be rendered for the user in the head mounted device based on the respective importance value.

According to an aspect of embodiments herein, the object is achieved by a network node configured to handle a set of data packets comprising pictures in an XR data transmission to be rendered for a user in a head mounted device associated with a communication device in a wireless communications network. The network node is further configured to:

Receive from an application server node, a set of data packets in the XR data transmission towards the communications device, wherein each applicable data packet in the set of data packets is adapted to indicate its assigned importance value, which importance value is adapted to indicate whether the data packet comprises a leading-edge part of the pictures or a trailing-edge part of the pictures,
obtain a decision of whether the data packets in the set of data packets are to be rendered for the user in the head mounted device, based on the respective importance value, and
based on the decision, schedule the data packets in the set of data packets in the XR data transmission to be sent to the communications device and to be rendered for the user.

According to an aspect of embodiments herein, the object is achieved by a core network node configured to handle a set of data packets comprising pictures in an XR data transmission to be rendered for a user in a head mounted device associated with a communication device in a wireless communications network. The core network node is further configured to:

Receive from an application server node, a set of data packets in the XR data transmission towards the communications device, wherein at least one or more of the data packets is adapted to indicate a respective assigned importance value, wherein the respective importance value is adapted to indicate whether its respective data packet comprises a leading-edge part or a trailing-edge part of the pictures,
based on the indicated importance value, decide a relevant QoS flow for at least each data packet in the set of data packets that comprises the importance value, and map the QoS flow to a corresponding DRB setup to handle that QoS flow,
send towards the communications device, via a network node, the data packets in the set of data packets, in its respective mapped DRB, wherein the data packets indicate its respective assigned importance value, and further indicate its respective decided relevant QoS flow,
wherein the data packets in the set of data packets are adapted to be decided to be rendered for the user in the head mounted device based on the respective importance value and decided relevant QoS flow. That is to be rendered in the head mounted device for the user.

Thanks to that the packets indicate respective relevant QoS flow and importance value relating to leading-edge part or a trailing-edge part of the pictures, flow differentiation may be used when deciding when and/or if a data packet shall be rendered for the user in the head mounted device. This results in an improved way of handling data packets comprising pictures in an XR data transmission in a wireless communications network. This in turn results in an improved Quality of Experience (QoE) and increases the satisfaction of the XR user in the wireless communications network.

### BRIEF DESCRIPTION OF THE DRAWINGS

Examples of embodiments herein are described in more detail with reference to attached drawings in which:

FIG. 1 is a schematic block diagram illustrating prior art.

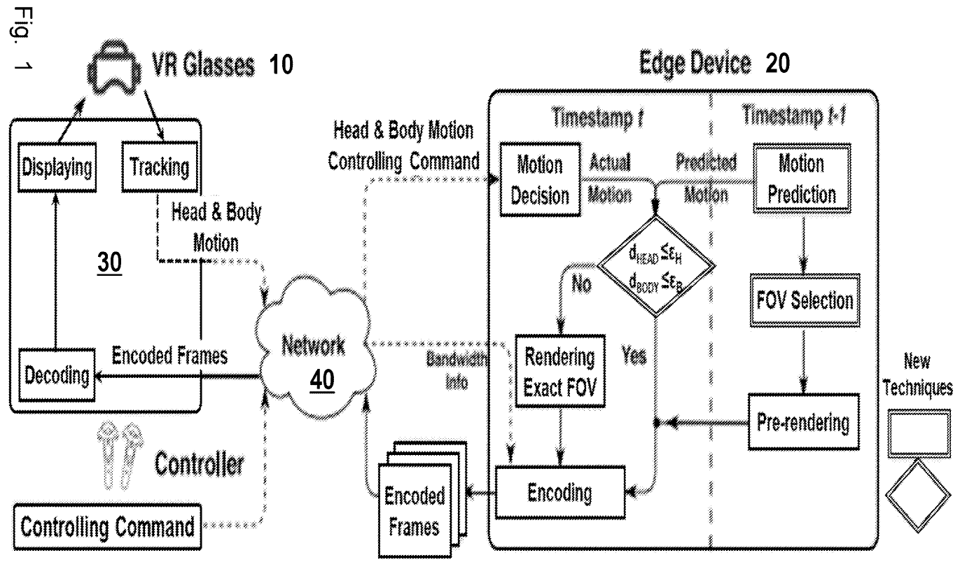

FIG. 2a is a schematic block diagrams illustrating embodiments of a wireless communications network.

FIG. 2b is a schematic block diagram illustrating embodiments herein.

FIG. 3 is a combined flowchart and signaling diagram depicting embodiments of a method.

FIG. 4 is a flowchart depicting embodiments of a method in an application server node.

FIG. 5 is a flowchart depicting embodiments of a method in a network node.

FIG. 6 is a flowchart depicting embodiments of a method in a core network node.

FIG. 7 is a schematic block diagram illustrating embodiments herein.

FIGS. 8a and b are schematic block diagrams illustrating an embodiment of an application server node.

FIGS. 9a and b are schematic block diagrams illustrating an embodiment of a network node.

FIGS. 10a and b are schematic block diagrams illustrating an embodiment of a core network node.

### DETAILED DESCRIPTION

Example embodiments herein provide methods for enabling a finer grade use of a 5G QoS priority mechanism, e.g. by establishing and disclosing the most important packets of the data to be sent to the head mounted device of the user over a data connection including the wireless, 5G, connection.

The direction and speed of the head movement are identified e.g. along with an estimation of the stop of the movement. The pictures to be displayed on the HMD due to this movement are identified along with their order to be displayed. Hence, the pictures are decided to be rendered for the user in the head mounted device based on the respective importance value relating to whether pictures have a leading edge and a trailing edge may be viewed. In some embodiments, the leading edge pictures are disclosed before some trailing edge pictures.

Example embodiments herein provide means for a 5G system to fully utilize the flow-based QoS mechanism standardized in 3GPP.

Hence, with some of these embodiments, means for 5G to use flow differentiation when it is really needed is provided. E.g. in terms of being applied for most critical and/or relevant picture data packets, such as pixels-bits-packets, in a media stream such as an XR data transmission between a rendering node referred to as an application server node, and a media consumer, referred to as user of a head mounted device. As mentioned above, this results in an improved QoE and hence increases the satisfied XR users in the wireless communications network.

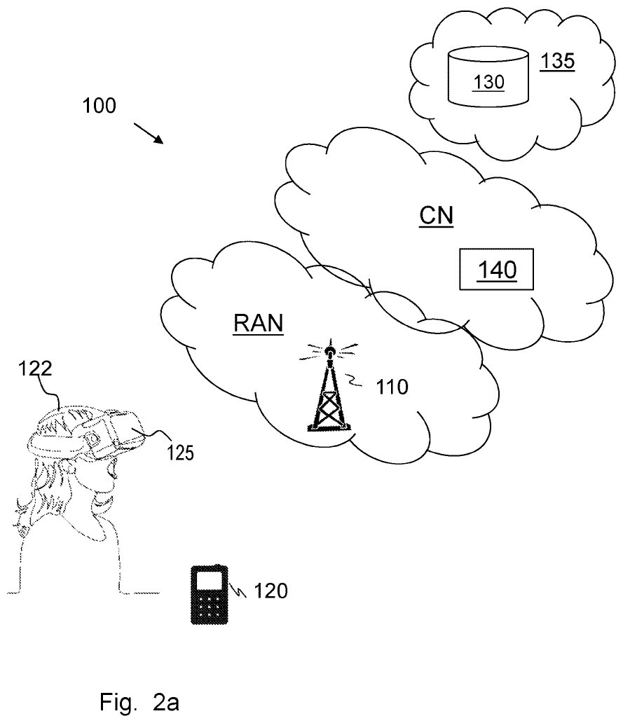

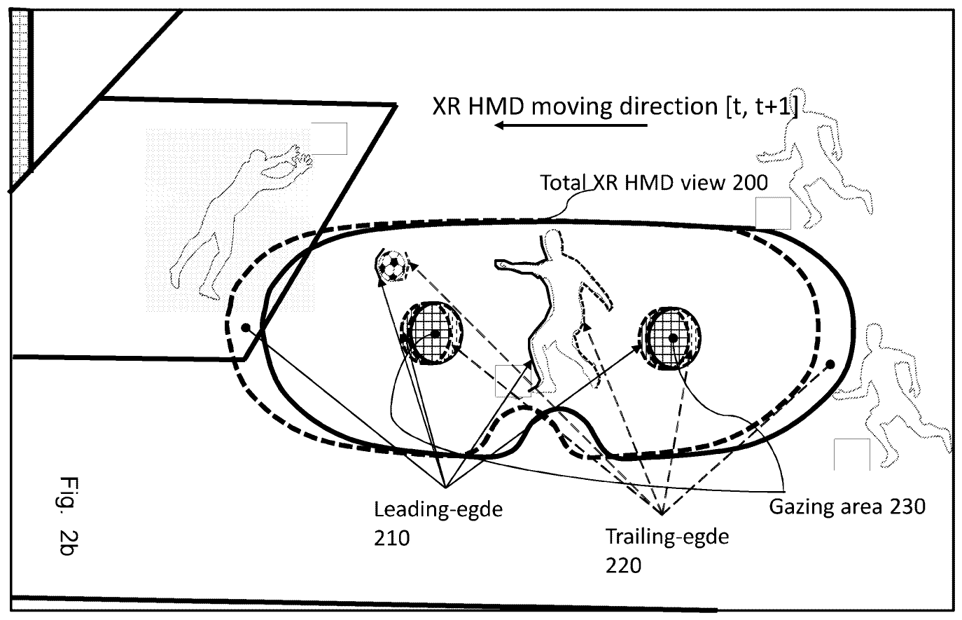

FIG. 2a is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes such as a network node 110 operate in the wireless communications network 100, by means of antenna beams, referred to as beams herein. The RAN node 110 e.g. provides a number of cells and may use these cells for communicating with e.g. a communication device 120. The RAN node 110 may be a transmission and reception point e.g. a radio access network node such as a base station, e.g. a radio base station such as a NodeB, an evolved Node B (eNB, eNodeB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a communication device within any cell served by the network node 110 depending e.g. on the radio access technology and terminology used.

Communications devices operate in the wireless communications network 100, such as a communication device 120. The communication device 120 may provide radio coverage by means of a number of antenna beams 127, also referred to as beams herein.

The communication device 120 may e.g. be a UE, an NR device, a mobile station, a wireless terminal, an NB-IOT device, an eMTC device, an NR RedCap device, a CAT-M device, a Wi-Fi device, an LTE device and a non-access point (non-AP) STA, a STA, that communicates via a base station such as e.g. the network node 110, one or more Access Networks (AN), e.g. RAN, to one or more core networks (CN). It should be understood by the skilled in the art that the communication device 120 relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

The communication device 120 handles data packets comprising pictures such as e.g. video data, arriving from an application server node 130 in XR data transmissions to be rendered for users such as a user 122 in a head mounted device 125. The communication device 120 is associated to and/or accessible to the head mounted device 125. The head mounted device 125 may e.g. be an HMD, VR glasses, or a VR headset etc

Application servers such as an application server node 130, operates in the wireless communications network 100, e.g. in the Internet and/or a cloud 135. The application server node 130, may e.g. be referred to as a XR rendering entity.

The application server node 130 handles data packets comprising pictures such as e.g. video data, to be sent in XR data transmissions to be rendered for users such as the user 122 in the head mounted device 125.

Core network nodes such as a core network node 140 operate in the CN of the wireless communications network 100. The core network node 140 handles the data packets comprising pictures such as e.g. video data from the application server node 130, to be sent in XR data transmissions towards the communication device 120 to be rendered for users such as a user 122 in the head mounted device 125. The core network node 140 may e.g. be an User Plane Function (UPF) node.

Examples of embodiments herein may relate to a head mounted device, such as an HMD, FoV 200 as illustrated by FIG. 2b.

The XR HMD moving direction for a time t and a preceding time t+1, e.g. a predicted time, is shown with an arrow pointing to left in FIG. 2b. The current Total XR HMD view 200 is marked with an unbroken line at the time t, and with a dashed line at the time t+1 for the “contour” of the HMD FoV and respective gazing areas.

It should be noted that there may be some discrepancy with respect to “unbroken-dashed nomenclature since unbroken/dased line type is also used as illustration for the “leading and training areas” of e.g. the kicker and the ball.

The pictures are “marked” with different importance if there are in the leading edge 210 or trailing edge 220 of the current total XR HMD view 200 such as dFOV, at the time t+1 based on the head and eye movement e.g. a gazing area 230, during the movement, of the user.

The leading-egde 210 and trailing-egde 220 pictures may e.g. comprise pixels and/or bits and/or data packets. The leading-edge pictures may be important for perception of e.g. low-lag overlay. This means that leading-edge pictures should be prioritized for transmission in case the connection is congested for keeping or improving the QoE of the user. While the trailing-egde pictures may be less important.

Gazing area 230 comprises high-quality rendering performed in the HMD FoV 200 in hashed areas.

The data packets comprising pictures form a real-time video packet stream that is being sent to the head mounted device. The pictures importance marking is e.g. reflected in respective (video) data packet header. The importance may e.g. be reflected by means of different Internet Protocol (IP) packets such as, IPv4 Type Of Service (TOS) or IPv6 Traffic Class (TC) field, or transport protocol port number. These IP header fields, TOS or TC, are usually visible to the 5G wireless communications network.

The information in the packet header may then be used by a network node the access network for differentiated transmission of the packets over the links.

The above-described problem is addressed in a number of embodiments, some of which should be seen as alternatives, while some may be used in combination.

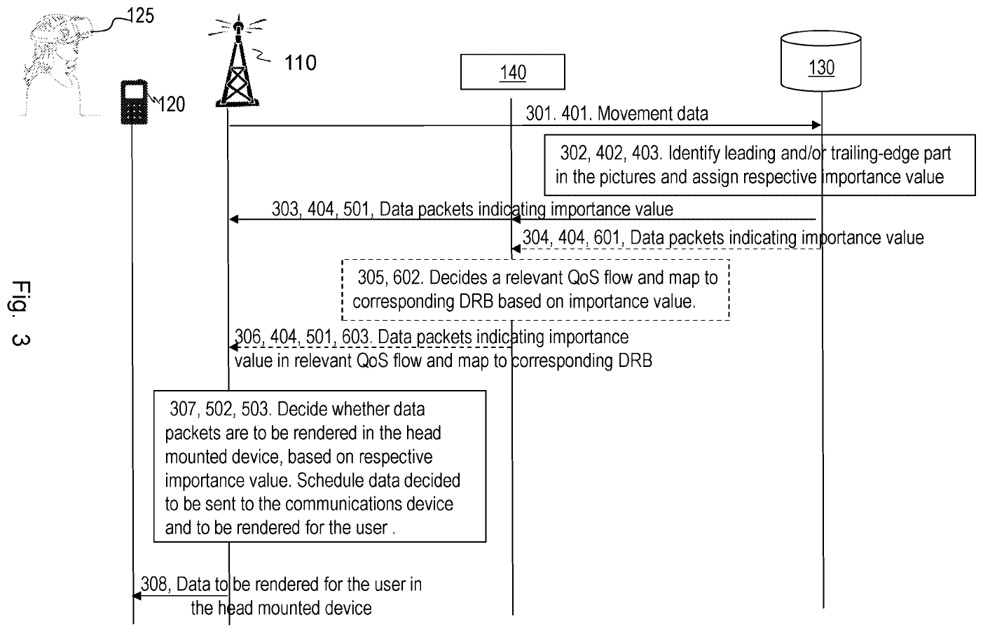

FIG. 3 depicts a combined flowchart and signaling diagram of an example overview of the methods as performed in the application server 130, the network node 110 and the core network node 140 for for handling a set of data packets comprising pictures, in an XR data transmission to be rendered for the user 122 in the head mounted device 125.

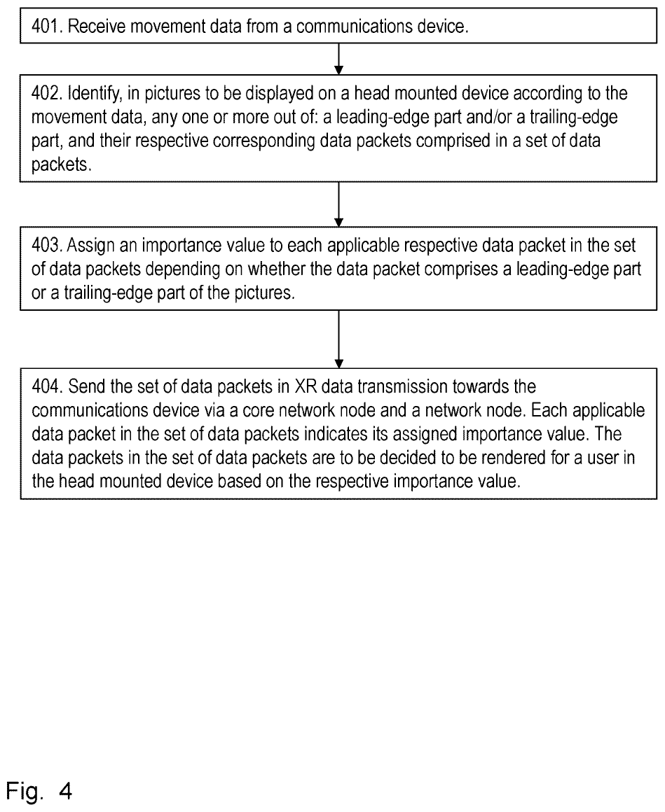

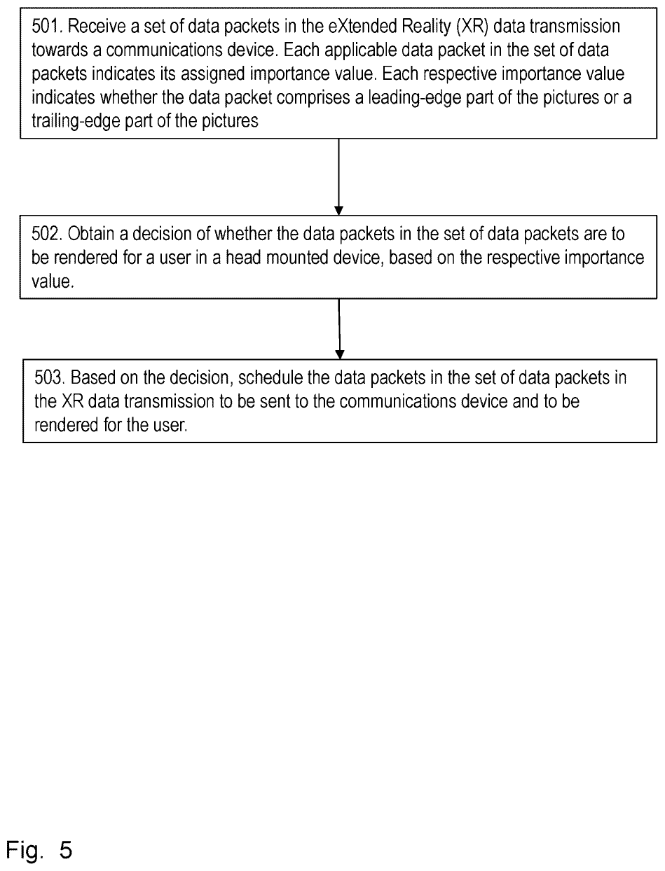

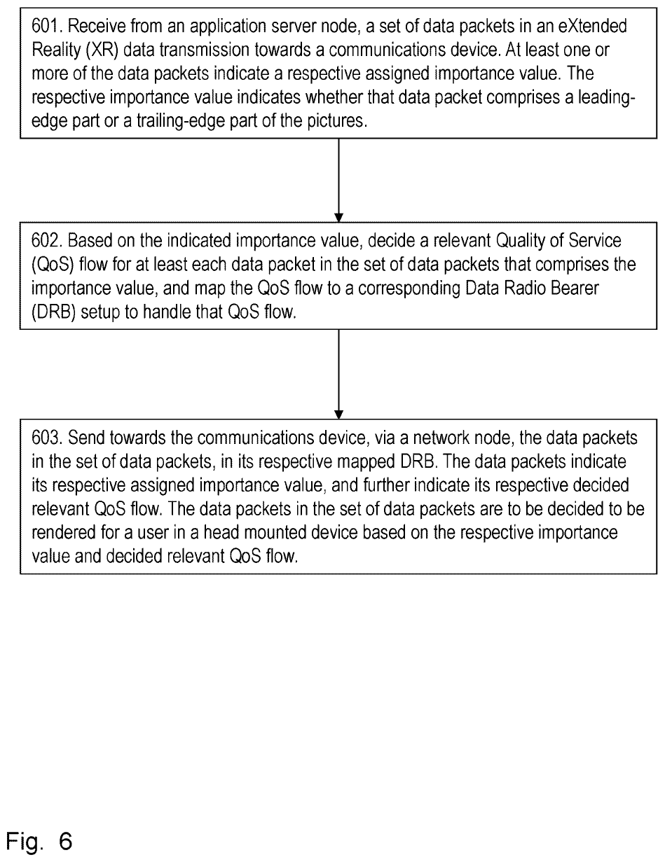

FIG. 4 shows example embodiments of the method seen in the view of the application server node 130, FIG. 5 shows example embodiments of the method seen in the view of the network node 110, and FIG. 6 shows example embodiments of the method seen in the view of the core network node 140. FIG. 3 depicts the example overview of the method as performed in the application server 130, the network node 110 and the core network node 140, it should therefore be seen together with respective FIG. 4, FIG. 5 and FIG. 6. The reference numbers of the Actions in FIG. 3 are corresponding to the reference numbers of the Actions of respective FIG. 4, FIG. 5 and FIG. 6. FIGS. 3-6 describes the method in a general way. A more detailed description will then follow.

Action 301. Movement data is sent from the communication device 120 to the application server node 130. This relates to Action 401 described below.

Action 302, The application server node 130 identifies leading and/or trailing-edge part in the pictures and assigns respective importance values e.g. to their corresponding data packet for transmission with respect to the movement of the head mounted device itself or with respect of user gazing updates. Thus, e.g. based on whether the data packets are leading-or trailing edge, or in-between, an importance value are assigned to them. This relates to Actions 402, 403 described below.

Action 303. The application server node 130 sends the data packets indicating importance value towards the communications device 120 via the core network node 140 and the network node 110. This relates to Actions 404 and 501 described below. The importance value may be reflected in a header of the data packet.

Action 304. In some embodiments, the data packets indicating importance value are received in the core network node 140. This relates to Actions 404 and 601 described below.

Action 305. In these embodiments, the core network node 140 decides a relevant QoS flow and map to corresponding DRB based on importance val. This relates to Action 602 described below.

Action 306. In these embodiments, the core network node 140 sends the data packets indicating importance value in relevant QoS flow and map to corresponding DRB to the network node 110. This relates to Actions 404, 501 and 603 described below.

Action 307. The network node 110 decides whether data packets are to be rendered in the head mounted device, based on respective importance value. E.g. the network node 110 may decide transmission order and whether data packets may be dropped/deleted, and how and which of said packet that are to be rendered in the head mounted device, based on respective importance value. Thus, the respective importance value e.g. in the data packet header is used to differentiate transmission of the data packets over the transmission links. This relates to Actions 502 and 503 described below.

Action 308, The network node 110 sends the data packets as scheduled to be rendered for the user 122 in the head mounted device 125.

FIG. 4 shows example embodiments of a method performed by the application server node 130, such as e.g. an XR rendering entity. The method is for handling a set of data packets comprising pictures such e.g. as video data. The data packets are comprised in an XR data transmission e.g. be in a media stream. The pictures in the data packets are to be rendered for the user 122 in the head mounted device 125 associated to the communication device 120 in the wireless communications network 100.

The head mounted device 125 being associated to the communication device 120 e.g. means that in some embodiments, the head mounted device 125 and communication device 120 may be considered as one unit as an HMD having an integrated cellular modem for connectivity. In other embodiments the head mounted device 125 may be connected to a separated device, e.g., via other wireless solutions such as Wi-Fi or by cable, where said separate device may be connected to internet cia cellular connectivity; in one such embodiment, it may be considered a laptop, tablet or smartphone catering for cellular connectivity while providing the HMD with “internet connection” via a tethered Wi-Fi (local) Wi-Fi network.

The method comprises the following actions, which actions may be taken in any suitable order. Optional actions are referred to as dashed boxes in FIG. 4. Please see FIG. 3 together with FIG. 4.

### Action 401

The application server node 130 receives movement data from the communication device 120. The movement data relates to a direction and a speed of a movement of any one or more out of: A head, body and an eye, of the user 122. This may e.g. be performed by on-device Intertia Measurement Unit (IMU) s such as accelerometers, motions sensors, that detects a motion and provides device with movements data in terms of respective position (x,y,z), velocity (x′, y′, z′) and acceleration (x″, y″, z″) values over a set of time samples (t1, t2, . . . tn), wherein

x′=dx/dt(speed in x dimension),

x″=dx′/dt=d(dx/dt)/dt(acceleration in x dimentsion)

In some embodiments, the movement data further comprises an estimation of when the movement stops.

### Action 402

The application server node 130 identifies, in the pictures to be displayed on the head mounted device 125 according to the movement data, any one or more out of: a leading-edge part and/or a trailing-edge part, and their respective corresponding data packets comprised in the set of data packets. This may be performed by predicting leading-edge part and/or a trailing-edge part based on the movement data. An example of this is illustrated in FIG. 2b described above.

### Action 403

The application server node 130 assigns an importance value to each applicable respective data packet in the set of data packets depending on whether the data packet comprises a leading-edge part or a trailing-edge part of the pictures, or e.g. none of the leading-edge part or trailing-edge part of the pictures.

To assign an importance value to each applicable respective data packet e.g. means that the data packet is associated with a value that will be used by function(s) that will prioritized which packet to transmit. The importance value may be reflected and/or carried in respective data packet header, such as video data packet header.

### Action 404

The application server node 130 then sends the set of data packets in the XR data transmission towards the communications device 120, e.g. via the core network node 140 and the network node 110. Each applicable data packet in the set of data packets indicates its assigned importance value. Applicable data packed means that only data packets that comprises an identified a leading-edge part or a trailing-edge part of the pictures are assigned an importance value. The data packets in the set of data packets are to be decided to be rendered for the user 122 in the head mounted device 125 based on the respective importance value.

In some embodiments, the application server node 130 sends the set of data packets in the XR data transmission by sending the data packets in the set of data packets within different IP-packets depending on whether the respective data packet comprises:
a leading-edge part of the pictures,
a trailing-edge part of the pictures, or
none of the leading-edge part or trailing-edge part of the pictures.

In some embodiments, the data packets in the set of data packets to be decided to be rendered for the user 122 in the head mounted device 125 based on the respective importance value relate to: deciding any one or more out of:
The order to render of the data packets for the user 122 in the head mounted device 125,
to send some of the data packets to be rendered for the user 122 in the head mounted device 125, and
delete some of the data packets to not be rendered for the user 122 in the head mounted device 125.

FIG. 5 shows example embodiments of a method performed by the network node 110 for handling a set of data packets comprising pictures in an XR data transmission to be rendered for the user 122 in the head mounted device 125 associated to the communication device 120 in the wireless communications network 100. The method comprises the following actions, which actions may be taken in any suitable order. Optional actions are referred to as dashed boxes in FIG. 5. Please see FIG. 3 together with FIG. 5.

### Action 501

The network node 110 receives a set of data packets from the application server node 130. The set of data packets is comprised in the XR data transmission towards the communications device 120. Each applicable data packet in the set of data packets indicates its assigned importance value. Each respective importance value indicates whether the data packet comprises a leading-edge part of the pictures or a trailing-edge part of the pictures.

In some embodiments, the network node 110 receives the set of data packets in the XR data transmission by receiving the data packets in the set of data packets within different IP-packets depending on whether the respective data packet comprises:
A leading-edge part of the pictures,
a trailing-edge part of the pictures, or
none of the leading-edge part or trailing-edge part of the pictures.

In some embodiments, the set of data packets in the XR data transmission towards the communications device 120, is received via a core network node 140. In some of these embodiments, each data packet out of set of data packets is received in a respective decided relevant QoS flow based on its importance value, in a corresponding DRB setup to handle that QoS flow. This may be according to any one or more out of:
A data packet comprising a leading-edge part of the pictures is received in a first QoS flow comprised in a first type of DRB,
a data packet comprising a trailing-edge part of the pictures is received in a second QoS flow comprised in a second type of DRB, and
a data packet comprising pictures which are neither a leading-edge part nor a trailing-edge part is received in a third QoS flow comprised in a third type of DRB.

### Action 502

The network node 110 obtains a decision of whether the data packets in the set of data packets are to be rendered for the user 122 in the head mounted device 125, based on the respective importance value. In some embodiments, the network node 110 obtains the decision by deciding it itself.

In some embodiments, the network node 110 obtains the decision of whether the data packets in the set of data packets to be rendered for the user 122 in the head mounted device 125 based on the respective importance value by: obtaining a decision of any one or more out of:
the order to render of the data packets for the user 122 in the head mounted device 125,
to send some of the data packets to be rendered for the user 122 in the head mounted device 125, and
delete some of the data packets to not be rendered for the user 122 in the head mounted device 125.

### Action 503

Based on the decision, the network node 110 schedules the data packets in the set of data packets in the XR data transmission to be sent to the communications device 120 and to be rendered for the user 122.

In some embodiments, the network node 110 schedules the data packets further based on which type of DRB the data packet is received in.

FIG. 6 shows example embodiments of a method performed by the core network node 140 for handling a set of data packets comprising pictures in an XR data transmission to be rendered for the user 122 in the head mounted device 125 associated to the communication device 120 in the wireless communications network 100. The method comprises the following actions, which actions may be taken in any suitable order. Optional actions are referred to as dashed boxes in FIG. 6. Please see FIG. 3 together with FIG. 6. It should be noted that the Actions in FIG. 6 are optional and are performed before the actions in FIG. 5.

### Action 601

The core network node 140 receives a set of data packets from the application server node 130. The set of data packets are comprised in the XR data transmission towards the communications device 120. At least one or more of the data packets indicate a respective assigned importance value. The respective importance value indicates whether its respective data packet comprises a leading-edge part or a trailing-edge part of the pictures.

In some embodiments, the core network node 140 receives the set of data packets in the XR data transmission by:
receiving the data packets in the set of data packets within different IP-packets depending on whether the respective data packet comprises:
   A leading-edge part of the pictures,
   a trailing-edge part of the pictures, or
   none of the leading-edge part or trailing-edge part of the pictures.

### Action 602

Based on the indicated importance value, the core network node 140 decides a relevant QoS flow for at least each data packet in the set of data packets that comprises the importance value and maps the QoS flow to a corresponding DRB setup to handle that QoS flow.

### Action 603

The core network node 140 then sends towards the communications device 120, via the network node 110, the data packets in the set of data packets, in its respective mapped DRB. The data packets indicate its respective assigned importance value, and further indicate its respective decided relevant QoS flow. The data packets in the set of data packets are to be decided to be rendered for the user 122 in the head mounted device 125 based on the respective importance value and decided relevant QoS flow.

In some embodiments, each data packet out of set of data packets sent in its respective decided relevant QoS flow based on its importance value, in the mapped corresponding DRB setup to handle that QoS flow comprises any one or more out of:

A data packet comprising a leading-edge part of the pictures is sent in a first QoS flow comprised in a first type of DRB,
a data packet comprising a trailing-edge part of the pictures is sent in a second QoS flow comprised in a second type of DRB, and
a data packet comprising pictures which are neither a leading-edge part nor a trailing-edge part is sent in a third QoS flow comprised in a third type of DRB.

The method described above will now be further explained and exemplified. The embodiments below may be combined with any suitable embodiment above.

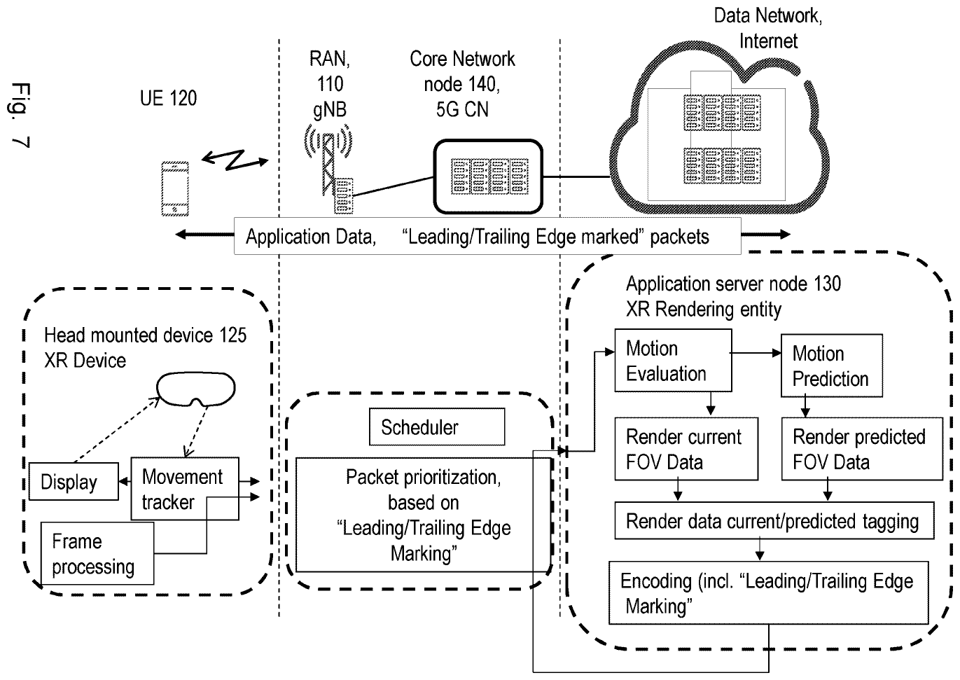

FIG. 7 depicts an overview of an example of embodiments herein. In FIG. 7, The application server node 130 is referred to as a XR rendering entity, and the head mounted device 125 is referred to as an XR device.

In FIG. 7, the data packets comprising pictures, also referred to as HMD data, is associated with (predicted) leading-edge areas is given priority e.g. using a leading-edge indicator considered as indicator for increased packet priority in RAN.

First, an example is explained how the service HMD service is setup using the functionality provided by the 5G network. Then an example of the method is explained of processing data and sending data using the identified leading and trailing edge data packets such as e.g. video frames.

### Prepare and Setup of the Head Mounted Device Service

The head mounted device service is referred to as the HMD service. Assume that an end-user service provider provides entertainment, such as TV, movies, games, etc., to users such as the user 122 with HMDs such as the head mounted device 125. They have an agreement with a telecommunication provider, for providing an improved QoS for HMD-e-Inc's users over the telecommunication provider's nationwide cellular network.

Therefore, end-user service provider has implemented an APP that communicates with the Network Exposure Function in the telecommunication provider's CN. An application (APP) and a Network Exposure Function (NEF) may exchange information and agree on the possible indications of the importance values, in e.g., IP-header TOS/TC field for which different QoS flows may apply, from the end-user service provider's entertainment server network such as the application server node 130.

In the core network node 140, the NEF may thereafter interact with an Application Function (AF) that takes the indications on how the IP-packets flows and their wanted QoS should be identified further to the Policy Control Function (PCF). The AF may thus initiate the QoS flow setup and the PCF. The PCF may then generate Policy Control and Charing rule(s) (PCC) for the end-user service provider's users, such as the user's 122, flows towards a Session Management Function (SMF). Based on the PCC, the SMF may generate among other things a Session Data Flow template for the UPF, the QoS Profile(s) for the network node 110 and the QoS rule for the communications device 120 e.g. a UE. Hence, now the user plane functions have the means to map IP-packet flows to QoS flows within the 5G system, for users of the end-user service providers HMD service.

### Data Transmission of the Frames

In some first exemplifying embodiments, the method may take the steps of:

Step 1). As mentioned above, movement data, also referred to as motion data, from the communication device 120 is sent to the Application server node 130. The movement data relates to a direction and a speed of a movement of any one or more out of: a head, body and an eye, of the user 122. The motion data may be sent in the uplink over a cellular connection from the head mounted device 125 such as XR Device, also referred to as XR managing entity.

The XR managing entity may be considered as a separate physical node or an entity, in a cellularly connected XR device such as the head mounted device 125.

Step 2) The application server node 130 such as the XR Rendering entity will receive the movement data from the from the communication device 120, e.g. the XR managing entity as connected to the communication device 120. This relates to and may be combined with Action 401 described above.

The application server node 130 then processes the movement data. The application server node 130 may establish user's FOV. The application server node 130 may determine what to-be-rendered areas that are associated with respective leading-edge and trailing-edge of the head mounted device's 125, such as XR device's, combined head, FOV, and/or gazing movement and render said pictures, such as pixels and/or blocks of pixels.

The application server node 130 may encode the pictures such as pixels into video frames, and may associate certain frames with leading/trailing edge attributes such as the indications of importance values.

This relates to and may be combined with Action 402 and Action 403 described above.

Step 3) The frames may be carried within different IP-packets depending on the associated leading/trailing edge attributes such as the indications of importance values, according to any one or more out of:
An IP-packet that contains one or more leading edge frames will have one certain value, such as 1 set in the TOS (IPv4) or TC (IPv6) header field
An IP-packet that contains one or more trailing edge frames will have one certain value, such as 2 set in the TOS (IPv4) or TC (IPv6) header field.
An IP-packet that contains one or more non-classified frames will have one certain value, such as 0 set in the TOS (IPv4) or TC (IPv6) header field.

This relates to and may be combined with Action 404 described above.

Step 4) The packets are then sent towards the receiver such as towards the communications device 120 and the XR managing entity that is accessible from or comprised in the communication device 120. This relates to and may be combined with Action 404 and Action 601 described above.

Step 5) The core network node 140 such as the UPF in a 5G Core Network examines the indications of importance values such as TOS or TC field of the received IP-packet, and may assign the packet to a right QoS flow. For this service there is e.g. three QoS flows, one for each TOS/TC value. This relates to and may be combined with Action 602 described above.

Step 6) Thus, there are then at least three QoS flows between the UPF of the core network node 140 and the network node 110. The data packets indicate its respective assigned importance value, and further indicate its respective decided relevant QoS flow. In this example, the IP data packets are encapsulated by the 5G protocol headers. Which in this example means that the QoS flows are identified by the QFI field of the packets that goes over the N3 interfaces. This relates to and may be combined with Action 501 and Action 603 described above.

Step 7) As the packets are received at the network node the QoS flows may be mapped to the correct Data Radio Bearer (DRB) that has been setup to handle the QoS flow. The QFI is now carried in the SDAP header over the air interface.

Step 8) A decision of whether the data packets in the set of data packets are to be rendered for the user 122 in the head mounted device 125, is obtained, e.g. taken based on the respective importance value. This may in this example comprise that it is decided that the packets mapped to a given Data Radio Bearer may have a different transmission priority over air interface between the network node 120 and the communications device 120, e.g. an NG-device such as a UE. The transmission priority may depend on the characteristics assigned to each DRB. The scheduler function of the network node 110 will use the transmission priority when obtaining the decision, e.g. decide such as select from which queue, each DRB has its own queue, it will select data from for the upcoming the XR data transmission occurrence. For example, if the scheduler function algorithm is Round Robin for the DRBs, it means that the scheduler will select data for the XR data transmission more often for the DRB with higher transmission priority. This relates to and may be combined with Action 502 and Action 503 described above.

Step 9) When received in the communications device 120, such as the UE the communications device 120 may at each 5G protocol layer, remove the corresponding header from a data packet and forward data packet according to higher layers e.g. in the communications device 120.

Step 10) When finally, at the application layer, the application will order the frames and remove frames that are deemed too late to help the play-out on the head mounted device 125 e.g. the HMD/XR glasses.

### Further Embodiments

In step 3) of the procedure above, alternative approaches may be considered, such as:
3-1) The frames may be carried within different IP-packets depending on associated leading and/or trailing edge attributes, according to a basic approach comprising any one or more out of:
   In some of these embodiments, an IP-packet that comprises one or more leading OR trailing edge frames will have one certain value, such as 1 set in the TOS (IPV4) or TC (IPv6) header field, and/or
   in some of these embodiments, an IP-packet that comprises one or more non-classified frames will have one certain value, such as 0 set in the TOS (IPV4) or TC (IPv6) header field.
3-2) The frames may be carried within different IP-packets depending on associated leading and/or trailing edge attributes, according to as previously mentioned approach here slightly more elaborated comprising any one or more out of:
   An IP-packet that comprises one or more leading edge frames will have one certain value, such as 1 set in the TOS (IPv4) or TC (IPv6) header field.
   An IP-packet that comprises one or more trailing edge frames will have one certain value, such as 2 set in the TOS (IPv4) or TC (IPv6) header field.
   An IP-packet that comprises one or more non-classified frames will have one certain value, such as 0 set in the TOS (IPv4) or TC (IPv6) header field.

These embodiments relate to and may be combined with Action 404 described above.

### Yet Further Embodiments

In one example scenario where the user 122 of the head mounted device 125 associated to the communication device (120) XR HMD user by some reason induces almost only leading and/or trailing edge pictures such as pixels, by intense headshaking, for example, the system may determine that “too many” is fulfilled and relax the suggested priority mechanism.

In that, in the step of associating leading/trailing edge attributes to certain frames, a % of the fraction of all frames threshold may also be considered to protect the system from assigning all and/or to many data packet frames with priority. The frames referred to herein relate to the frames of the data packets.

In step 2) as mentioned above, may then be performed according to:
2-1) The application server device 130, such as the XR rendering entity, may receive movement data from the from the communication device (120), such as e.g. from its accessed XR managing entity and process the motion data. The application server device 130 may establish the user's 122 FOV, determine what to-be-rendered areas that are associated with respective leading and trailing edge of the head mounted device's 125, such as the XR device's, combined head, FOV, and gazing motion and render said picture data, e.g. pixels/blocks of pixels. The application server device 130 may then encode pixels into video frames, and associate certain frames with importance value related to leading and/or trailing edge attributes according to any one or more out of:
   IF ratio of leading/trailing edge “pixels/blocks of pixels”>a % fraction of all frames threshold,
   Remove leading/trailing edge attribute OR
   Assign leading/trailing edge attribute with “non-classified frames”.

Then implicitly in the subsequent step 3), for said data packet frames considered as “lead and/or trailing edge”-relaxed due to too much FOV movement will end up as non-classified frames with a value 0 set in the TOS (IPv4) or TC (IPv6) header field.

This relates to and may be combined with Action 402 and Action 403 described above.

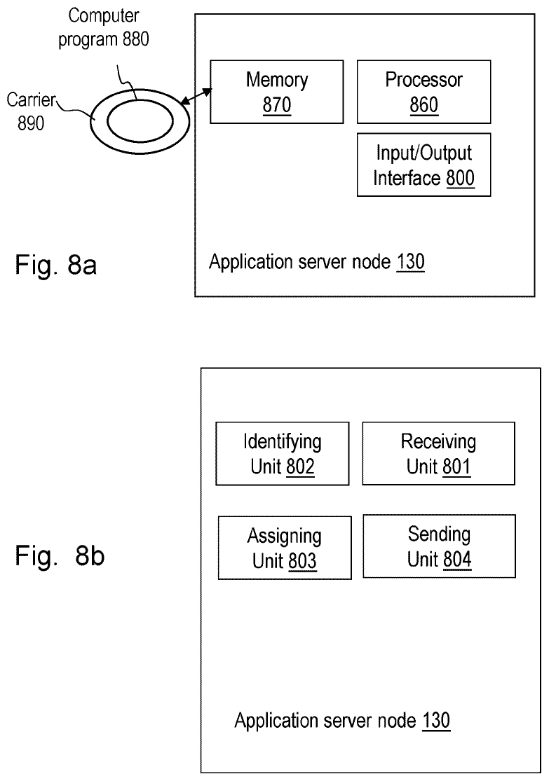

To perform the method actions above, the application server node 130 configured to handle a set of data packets comprising pictures in an XR data transmission to be rendered for a user 122 in a head mounted device 125 associated with a communication device 120 in a wireless communications network 100. The application server node 130 may comprise an arrangement depicted in FIGS. 8a and 8b.

The application server node 130 may comprise an input and output interface 800 configured to communicate e.g. with any one or more out of: the network node 110, the communication device 120, the head mounted device 125 and the core network node 140. The input and output interface 800 may comprise a wireless receiver not shown and a wireless transmitter not shown.

The application server node 130 is configured to, e.g. by means of a receiving unit 801 in the application server node 130, receive movement data from the communication device 120, which movement data is adapted to relate to a direction and a speed of a movement of any one or more out of: a head, body and an eye, of the user 125.

The application server node 130 is configured to, e.g. by means of an identifying unit 802 in the application server node 130, identify, in the pictures to be displayed on the head mounted device 125 according to the movement data, any one or more out of: a leading-edge part and/or a trailing-edge part, and their respective corresponding data packets comprised in the set of data packets.

The application server node 130 is configured to, e.g. by means of a assigning unit 803 in the application server node 130, assign an importance value to each applicable respective data packet in the set of data packets depending on whether the data packet comprises a leading-edge part or a trailing-edge part of the pictures,

The application server node 130 is configured to, e.g. by means of a sending unit 804 in the application server node 130, send the set of data packets in the XR data transmission towards the communications device 120 via a core network node 140 and a network node 110, wherein each applicable data packet in the set of data packets is adapted to indicate its assigned importance value, and wherein the data packets in the set of data packets are adapted to be decided to be rendered for the user 122 in the head mounted device 125 based on the respective importance value.

The application server node 130 is configured to, e.g. by means of the sending unit 804 in the application server node 130, send the set of data packets in the XR data transmission is by:
sending the data packets in the set of data packets within different Internet Protocol, IP,-packets depending on whether the respective data packet comprises:
   a leading-edge part of the pictures,
   a trailing-edge part of the pictures, or
   none of the leading-edge part or trailing-edge part of the pictures.

In some embodiments, the movement data is adapted to comprise an estimation of when the movement stops.

In some embodiments, the data packets in the set of data packets are adapted to be decided to be rendered for the user 122 in the head mounted device 125 based on the respective importance value relate to deciding any one or more out of:
the order to render of the data packets for the user 122 in the head mounted device 125,
to send some of the data packets to be rendered for the user 122 in the head mounted device 125, and
delete some of the data packets to not be rendered for the user 122 in the head mounted device 125.

The embodiments herein may be implemented through a respective processor or one or more processors, such as the processor 860 of a processing circuitry in the application server node 130, depicted in FIG. 8a together with computer program code for performing the functions and actions of the embodiments herein. The program code mentioned above may also be provided as a computer program product, for instance in the form of a data carrier carrying computer program code for performing the embodiments herein when being loaded into the application server node 130. One such carrier may be in the form of a CD ROM disc. It is however feasible with other data carriers such as a memory stick. The computer program code may furthermore be provided as pure program code on a server and downloaded to the application server node 130.

The application server node 130 may further comprise a memory 870 comprising one or more memory units. The memory comprises instructions executable by the processor in the application server node 130. The memory 870 is arranged to be used to store e.g. information, data, movement data, pictures, importance values, configurations, and applications to perform the methods herein when being executed in the application server node 130.

In some embodiments, a computer program 880 comprises instructions, which when executed by the at least one processor, cause the at least one processor of the application server node 130, to perform the actions above.

In some embodiments, a carrier 890 comprises the computer program 880, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the units in the application server node 130 described above may refer to a combination of analog and digital circuits, and/or one or more processors configured with software and/or firmware, e.g. stored in the application server node 130, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

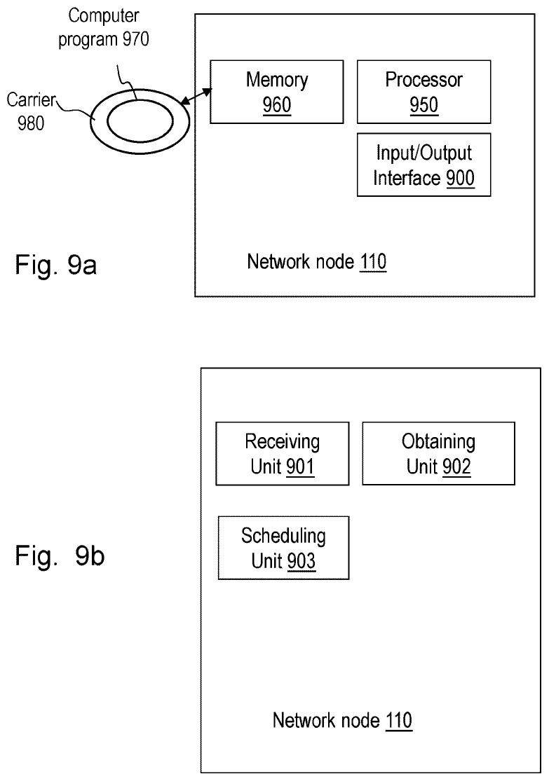

To perform the method actions above, the network node 110 configured to handle a set of data packets comprising pictures in an XR data transmission to be rendered for the user 122 in the head mounted device 125 associated with the communication device 120 in the wireless communications network 100. The network node 110 may comprise an arrangement depicted in FIGS. 9a and 9b.

The network node 110 may comprise an input and output interface 900 configured to communicate e.g. with any one or more out of: the application server node 130, the communication device 120, the head mounted device 125 and the core network node 140. The input and output interface 900 may comprise a wireless receiver (not shown) and a wireless transmitter (not shown).

The network node 110 is further configured to, e.g. by means of a receiving unit 901 in the network node 110, receive from an application server node 130, a set of data packets in the XR data transmission towards the communications device 120, wherein each applicable data packet in the set of data packets is adapted to indicate its assigned importance value, which importance value is adapted to indicate whether the data packet comprises a leading-edge part of the pictures or a trailing-edge part of the pictures.

The network node 110 is further configured to, e.g. by means of the receiving unit 901 in the network node 110, receive the set of data packets in the XR data transmission by:
receiving the data packets in the set of data packets within different Internet Protocol, IP,-packets depending on whether the respective data packet comprises:
   a leading-edge part of the pictures,
   a trailing-edge part of the pictures, or
   none of the leading-edge part or trailing-edge part of the pictures.

The network node 110 is further configured to, e.g. by means of an obtaining unit 902 in the network node 110, obtain a decision of whether the data packets in the set of data packets are to be rendered for the user 122 in the head mounted device 125, based on the respective importance value.

The network node 110 is further configured to, e.g. by means of the obtaining unit 902 in the network node 110, obtain the decision of whether the data packets in the set of data packets to be rendered for the user 122 in the head mounted device 125 based on the respective importance value by: obtaining a decision of any one or more out of:
the order to render of the data packets for the user 122 in the head mounted device 125,
to send some of the data packets to be rendered for the user 122 in the head mounted device 125, and
delete some of the data packets to not be rendered for the user 122 in the head mounted device 125.

The network node 110 is further configured to, e.g. by means of a scheduling unit 903 in the network node 110, based on the decision, schedule the data packets in the set of data packets in the XR data transmission to be sent to the communications device 120 and to be rendered for the user 122.

The network node 110 is further configured to, e.g. by means of the scheduling unit 903 in the network node 110, schedule the data packets in the set of data packets in the XR data transmission to be sent to the communications device 120 and to be rendered for the user 122 based on the decision, further based on which type of DRB the data packet is received in.

In some embodiments, the set of data packets in the XR data transmission towards the communications device 120, is arranged to be received via a core network node 140, and each the data packet out of set of data packets is arranged to be received in a respective decided relevant QoS flow based on its importance value, in a corresponding DRB setup to handle that QoS flow.

In some embodiments, each data packet out of set of data packets is arranged to be received in a respective decided relevant QoS flow based on its importance value, in a corresponding DRB setup to handle that QoS flow by any one or more out of:
a data packet comprising a leading-edge part of the pictures is arranged to be received in a first QoS flow comprised in a first type of DRB,
a data packet comprising a trailing-edge part of the pictures is arranged to be received in a second QoS flow comprised in a second type of DRB, and
a data packet comprising pictures which are neither a leading-edge part nor a trailing-edge part is arranged to be received in a third QoS flow comprised in a third type of DRB.

The embodiments herein may be implemented through a respective processor or one or more processors, such as the processor 950 of a processing circuitry in the network node 110, depicted in FIG. 9a together with computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 960 comprising one or more memory units. The memory comprises instructions executable by the processor in the network node 110. The memory 960 is arranged to be used to store e.g. information, movement data, pictures, importance values, configurations, and applications to perform the methods herein when being executed in the network node 110.

In some embodiments, a computer program 970 comprises instructions, which when executed by the at least one processor, cause the at least one processor of the network node 110, to perform the actions above.

In some embodiments, a carrier 980 comprises the computer program 970, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the units in the network node 110 described above may refer to a combination of analog and digital circuits, and/or one or more processors configured with software and/or firmware, e.g. stored in the network node 110, that when executed by the respective one or more processors such as the processors described above. One or more of these processors, as well as the other digital hardware, may be included in a single Application-Specific Integrated Circuitry ASIC, or several processors and various digital hardware may be distributed among several separate components, whether individually packaged or assembled into a system-on-a-chip SoC.

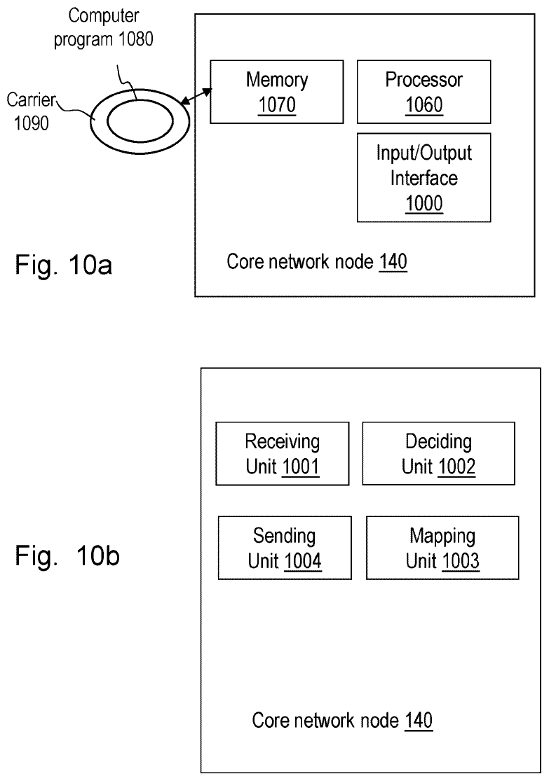

To perform the method actions above, the core network node 140 configured to handle a set of data packets comprising pictures in an XR data transmission to be rendered for the user 122 in the head mounted device 125 associated with the communication device 120 in the wireless communications network 100. The core network node 140 may comprise an arrangement depicted in FIGS. 10a and 10b.

The core network node 140 may comprise an input and output interface 1000 configured to communicate e.g. with any one or more out of: the network node 110, the communication device 120, the head mounted device 125 and the application server node 130. The input and output interface 700 may comprise a wireless receiver not shown and a wireless transmitter not shown.

The core network node 140 is configured to, e.g. by means of a receiving unit 1001 in the core network node 140, receive from an application server node 130, a set of data packets in the XR data transmission towards the communications device 120, wherein at least one or more of the data packets is adapted to indicate a respective assigned importance value, wherein the respective importance value is adapted to indicate whether its respective data packet comprises a leading-edge part or a trailing-edge part of the pictures.

The core network node 140 is configured to, e.g. by means of the receiving unit 1001 in the core network node 140, receive the set of data packets in the XR data transmission by:
receiving the data packets in the set of data packets within different IP-packets depending on whether the respective data packet comprises:
   a leading-edge part of the pictures,
   a trailing-edge part of the pictures, or
   none of the leading-edge part or trailing-edge part of the pictures.

The core network node 140 is configured to, e.g. by means of a deciding unit 1002 and/or a mapping unit 1003 in the core network node 140, based on the indicated importance value, decide a relevant QoS, flow for at least each data packet in the set of data packets that comprises the importance value, and map the QoS flow to a corresponding DRB setup to handle that QoS flow.

The core network node 140 is configured to, e.g. by means of a sending unit 1004 in the core network node 140, send towards the communications device 120, via a network node 110, the data packets in the set of data packets, in its respective mapped DRB. The data packets indicate its respective assigned importance value, and further indicate its respective decided relevant QoS flow. The data packets in the set of data packets are adapted to be decided to be rendered for the user 122 in the head mounted device 125 based on the respective importance value and decided relevant QoS flow.

In some embodiments, each data packet out of set of data packets are arranged to be sent, e.g. by means of the sending unit 1004 in the core network node 140, in its respective decided relevant QoS flow based on its importance value, in the mapped corresponding DRB setup to handle that QoS flow by any one or more out of:
a data packet comprising a leading-edge part of the pictures is arranged to be sent in a first QoS flow comprised in a first type of DRB,
a data packet comprising a trailing-edge part of the pictures is arranged to be sent in a second QoS flow comprised in a second type of DRB, and
a data packet comprising pictures which are neither a leading-edge part nor a trailing-edge part is arranged to be sent in a third QoS flow comprised in a third type of DRB.

The embodiments herein may be implemented through a respective processor or one or more processors, such as the processor 1060 of a processing circuitry in the core network node 140, depicted in FIG. 10a together with computer program code for performing the functions and actions of the embodiments herein. The program code mentioned above may also be provided as a computer program product, for instance in the form of a data carrier carrying computer program code for performing the embodiments herein when being loaded into the core network node 140. One such carrier may be in the form of a CD ROM disc. It is however feasible with other data carriers such as a memory stick. The computer program code may furthermore be provided as pure program code on a server and downloaded to the core network node 140.

The core network node 140 may further comprise a memory 1070 comprising one or more memory units. The memory comprises instructions executable by the processor in the core network node 140. The memory 1070 is arranged to be used to store e.g. information, movement data, pictures, importance values, configurations, and applications to perform the methods herein when being executed in the core network node 140.

In some embodiments, a computer program 1080 comprises instructions, which when executed by the at least one processor, cause the at least one processor of the core network node 140, to perform the actions above.

In some embodiments, a carrier 1090 comprises the computer program 1080, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the units in the core network node 140 described above may refer to a combination of analog and digital circuits, and/or one or more processors configured with software and/or firmware, e.g. stored in the core network node 140, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

Abbreviation Explanation

| APP | Application |
|---|---|
| AF | Application Function |
| DRB | Data Radio Bearer |
| FOV | Field of View |
| gNB | Next Generation NodeB |
| HMD | Head Mounted Display |
| HMD-e-Inc | HMD-entertainment Inc. |
| IP | Internet Protocol |
| NEF | Network Exposure Function |
| NG-RAN | Next Generation RAN |
| PCC | Policy Control and Charing (rules) |
| PCF | Policy Control Function |
| RAN | Radio Access Network |
| SDAP | Service Data Adaptation Protocol |
| SDF | Session Data Flow |
| SMF | Session Management Function |
| TC | Traffic Class (field, IPv6) |
| TOS | type of service (IPv4) |
| QFI | QoS Flow ID |
| QoE | Quality of Experience |
| QOS | Quality of Service |
| UE | User Equipment |
| UPF | User Plane Function |
| XR | extended Reality; {Augmented, |
| | Virtual, Mixed, “whatever”} Reality |

1. A method performed by an application server node (130), for handling a set of data packets comprising pictures, in an extended Reality, XR, data transmission to be rendered for a user (122) in a head mounted device, (125), associated to a communication device (120) in a wireless communications network (100), the method comprising:
receiving (401) movement data from the communication device (120), which movement data relates to a direction and a speed of a movement of any one or more out of: a head, body and an eye, of the user (122),
identifying (402), in pictures to be displayed on the head mounted device (125) according to the movement data, any one or more out of: a leading-edge part and/or a trailing-edge part, and their respective corresponding data packets comprised in the set of data packets,
assigning (403) an importance value to each applicable respective data packet in the set of data packets depending on whether the data packet comprises a leading-edge part or a trailing-edge part of the pictures,
sending (404) the set of data packets in the XR data transmission towards the communications device (120) via a core network node (140) and a network node (110), wherein each applicable data packet in the set of data packets indicates its assigned importance value, and wherein the data packets in the set of data packets are to be decided to be rendered for the user (122) in the head mounted device (125) based on the respective importance value.

2. The method according to claim 1, wherein the movement data further comprises an estimation of when the movement stops.

3. The method according to claim 1, wherein sending (404) of the set of data packets in the XR data transmission is performed by:
sending the data packets in the set of data packets within different Internet Protocol, IP,-packets depending on whether the respective data packet comprises:
a leading-edge part of the pictures,
a trailing-edge part of the pictures, or
none of the leading-edge part or trailing-edge part of the pictures.

4. The method according to claim 1, wherein the data packets in the set of data packets to be decided to be rendered for the user (122) in the head mounted device (125) based on the respective importance value relate to: deciding any one or more out of:
the order to render of the data packets for the user (122) in the head mounted device (125),
to send some of the data packets to be rendered for the user (122) in the head mounted device (125), and
delete some of the data packets to not be rendered for the user (122) in the head mounted device (125).

5-6. (canceled)

7. A method performed by a network node (110) for handling a set of data packets comprising pictures in an extended Reality, XR, data transmission to be rendered for a user (122) in a head mounted device (125) associated to a communication device (120) in a wireless communications network (100), the method comprising:
receiving (501) from an application server node (130), a set of data packets in the XR data transmission towards the communications device (120), wherein each applicable data packet in the set of data packets indicates its assigned importance value, which importance value indicates whether the data packet comprises a leading-edge part of the pictures or a trailing-edge part of the pictures,
obtaining (502) a decision of whether the data packets in the set of data packets are to be rendered for the user (122) in the head mounted device (125), based on the respective importance value, and
based on the decision, scheduling (503) the data packets in the set of data packets in the XR data transmission to be sent to the communications device (120) and to be rendered for the user (122).

8. The method according to claim 7, wherein receiving (501) of the set of data packets in the XR data transmission comprises:
receiving the data packets in the set of data packets within different Internet Protocol, IP,
packets depending on whether the respective data packet comprises:
a leading-edge part of the pictures,
a trailing-edge part of the pictures, or
none of the leading-edge part or trailing-edge part of the pictures.

9. The method according to claim 7, wherein obtaining (502) the decision of whether the data packets in the set of data packets to be rendered for the user (122) in the head mounted device (125) based on the respective importance value comprises:
obtaining a decision of any one or more out of:
the order to render of the data packets for the user (122) in the head mounted device (125),
to send some of the data packets to be rendered for the user (122) in the head mounted device (125), and
delete some of the data packets to not be rendered for the user (122) in the head mounted device (125).

10. The method according to claim 7, wherein the set of data packets in the XR data transmission towards the communications device (120), is received via a core network node (140), and each the data packet out of set of data packets is received in a respective decided relevant QoS flow based on its importance value, in a corresponding Data Radio Bearer, DRB, setup to handle that QoS flow.

11. The method according to claim 7, wherein each data packet out of set of data packets received in a respective decided relevant QoS flow based on its importance value, in a corresponding Data Radio Bearer, DRB, setup to handle that QoS flow comprises any one or more out of:
a data packet comprising a leading-edge part of the pictures is received in a first QoS flow comprised in a first type of DRB,
a data packet comprising a trailing-edge part of the pictures is received in a second QoS flow comprised in a second type of DRB, and
a data packet comprising pictures which are neither a leading-edge part nor a trailing-edge part is received in a third QoS flow comprised in a third type of DRB.

12. The method according to claim 7, wherein the scheduling (503) of the data packets in the set of data packets in the XR data transmission to be sent to the communications device (120) and to be rendered for the user (122) based on the decision, further is based on which type of DRB the data packet is received in.

13-23. (canceled)

24. A network node (110) configured to handle a set of data packets comprising pictures in an extended Reality, XR, data transmission to be rendered for a user (122) in a head mounted device (125) associated to a communication device (120) in a wireless communications network (100), the network node (110) further being configured to:
receive from an application server node (130), a set of data packets in the XR data transmission towards the communications device (120), wherein each applicable data packet in the set of data packets is adapted to indicate its assigned importance value, which importance value is adapted to indicate whether the data packet comprises a leading-edge part of the pictures or a trailing-edge part of the pictures,
obtain a decision of whether the data packets in the set of data packets are to be rendered for the user (122) in the head mounted device (125), based on the respective importance value, and
based on the decision, schedule the data packets in the set of data packets in the XR data transmission to be sent to the communications device (120) and to be rendered for the user (122).

25. The network node (110) according to claim 24, further configured to receive the set of data packets in the XR data transmission by:
receiving the data packets in the set of data packets within different Internet Protocol, IP,-packets depending on whether the respective data packet comprises:
a leading-edge part of the pictures,
a trailing-edge part of the pictures, or
none of the leading-edge part or trailing-edge part of the pictures.

26. The network node (110) according to claim 24, further configured to obtain the decision of whether the data packets in the set of data packets to be rendered for the user (122) in the head mounted device (125) based on the respective importance value by: obtaining a decision of any one or more out of:
the order to render of the data packets for the user (122) in the head mounted device (125),
to send some of the data packets to be rendered for the user (122) in the head mounted device (125), and
delete some of the data packets to not be rendered for the user (122) in the head mounted device (125).

27. The network node (110) according to claim 24, wherein the set of data packets in the XR data transmission towards the communications device (120), is arranged to be received via a core network node (140), and each the data packet out of set of data packets is arranged to be received in a respective decided relevant QoS flow based on its importance value, in a corresponding Data Radio Bearer, DRB, setup to handle that QoS flow.

28. The network node (110) according to claim 24, wherein each data packet out of set of data packets is arranged to be received in a respective decided relevant QoS flow based on its importance value, in a corresponding Data Radio Bearer, DRB, setup to handle that QoS flow by any one or more out of:
a data packet comprising a leading-edge part of the pictures is arranged to be received in a first QoS flow comprised in a first type of DRB,
a data packet comprising a trailing-edge part of the pictures is arranged to be received in a second QoS flow comprised in a second type of DRB, and
a data packet comprising pictures which are neither a leading-edge part nor a trailing-edge part is arranged to be received in a third QoS flow comprised in a third type of DRB.

29. The network node (110) according to claim 24, configured to schedule the data packets in the set of data packets in the XR data transmission to be sent to the communications device (120) and to be rendered for the user (122) based on the decision, further based on which type of DRB the data packet is received in.

30-32. (canceled)
